(19) United States
(12) Patent Application Publication
(10) Pub. No.: US 2025/0034865 A1
(43) Pub. Date: Jan. 30, 2025

(54) CURTAIN WALL

(71) Applicants: LAURENSL EONARD R. CLAEYS, ZANDHOVEN (BE); STEPHANIE CATHARIA R. CLAYES, ZANDHOVEN (BE); NAUSIKAA ELS P. CLAEYS, ZANDHOVEN (BE)

(72) Inventor: ERIC CLAEYS, ZANDHOVEN (BE)

(21) Appl. No.: 18/697,121

(22) PCT Filed: Oct. 3, 2022
(86) PCT No.: PCT/EP2022/077477

§ 371 Date: Mar. 29, 2024

(30) Foreign Application Priority Data
Oct. 4, 2021 (EP) 21200644.9

(51) Int. Cl. E04B 2/96

(52) U.S. Cl. CPC E04B 2/965

(57) ABSTRACT

Curtain wall (1) comprising mullions (2) formed by mullion profiles (5), transoms (3) formed by transom profiles (14) and panels (4), wherein the mullions (3) are installed vertically, with the transoms (3) being fixed at right angles to the mullions (2), wherein the transoms (3) and the mullions (2) (5) define rectangular openings, wherein the panels (4) are placed in said openings to close these openings, characterized in that the panels (4) are secured by means of first glazing beads (34), that are attached to a said mullion profile (5) by means of first positioning aids (36), wherein the first positioning aids (36) and said mullion profiles (5) are designed such that the first positioning aids (36) can be attached to a said mullion profile (5), wherein the first positioning aids (36) and the first glazing beads (34) are designed to snap the first glazing beads (34) onto the mullion profiles (5) through a rotational movement, guided by said first positioning aids (36).

### TECHNICAL FIELD

The present disclosure relates to a curtain wall and to a method for installing said curtain wall.

### BACKGROUND

This is a structure comprising of mullion profiles and transom profiles in which panels, usually glass panels, but closed panels are also possible, are placed to form a non-load-bearing outer wall.

A disadvantage of the known curtain walls is that the mullion profiles and transom profiles are designed in such a way that construction must be done from the outside.

An example of such a known curtain wall is described in U.S. Pat. No. 3,081,849, the mullions and transoms being constructed from an inner profile on the inside of the curtain wall and from an outside profile on the outside thereof, with the outer profile being snapped along the outside of the curtain wall and the panels with their side edges being fitted between the two profiles with the aid of seals.

Other examples are known from U.S. Pat. No. 4,756,132 and JPS 57.190086 in which glazing beads must be hooked together with their seals in an inner profile in a direction perpendicular to the plane of the facade, before the panels can be placed along the outside of the facade and secured by means of an outer profile that is snapped or screwed into place.

An installation from the outside is not only a disadvantage, but it is in no way technically similar to a facade system mountable from the inside. Both execution techniques have virtually no similarities.

This fact is not related to the knowledge that an installation at certain heights is not only complex, but requires scaffolding or suspended working platforms and is dangerous for the persons who perform this work and for those who might pass under it.

An installation of the panels from the inside would be much easier and safer because there are floors at regular intervals.

However, there is a problem in this that glazing beads, which are necessary to secure a panel firmly against the mullion profiles and the transom profiles, are not easily applied.

The patent application US 2003/0226324 describes a curtain wall system, wherein the applicant claims that this system is suitable for installing and replacing the panels both from the outside and from the inside of the curtain wall if necessary. However, this is not possible without certain parts of the mullions and transoms being disassembled to provide enough room to rotate the panels from the inside of the curtain wall without having the panels' upper or lower side edge collide with an inner wall of the transoms.

The US 2003/0226324 curtain wall system provides for the installation of single and double glazed glass panels, in the case of double glazing the panels are sealed between rubber seals and in the case of a single glazing the difference in thickness with the double glazing is accommodated by one of the aforementioned seals attached to a glazing bead, wherein the glazing bead and this seal, are first hooked together in a mullion profile or in transom profile and then rotated in with force.

Mounting the glazing beads in such a way is not only difficult, but also contains the risk of damage to the panels.

WO 2017/008014 describes a curtain wall system that solves the above mentioned problems.

However, it has been experienced that, for instance when the curtain wall is installed by persons having had insufficient training, the glazing beads are sometimes improperly attached to the mullion profiles such that the glazing panels are not properly secured, e.g. the glazing beads are sometimes improperly aligned with respect to the glass panels.

There is thus still a need for an improved way of fixing the panels of a curtain wall system installed from the inside of a building.

### SUMMARY

The object of the invention is to provide a solution to the aforementioned and other disadvantages, and to this end it concerns a curtain wall comprising of one or more mullions, formed by mullion profiles, one or more transoms, formed by transom profiles and one or more panels, preferably glass panels, wherein the one or more mullions extend vertically, wherein the one or more transoms are attached perpendicular to the one or more mullions, wherein the one or more transoms and the one or more mullions define rectangular openings, wherein the one or more panels are positioned in said openings to close these openings, wherein the panels are fitted with their side edges in a rabbet of the million profiles and the transom profiles with the aid of seals and wherein the rabbets in the mullions have a fixed indivisible width and the one or more panels along the inside of the curtain wall are fixed in the mullion profiles by means of the first glazing beads, these glazing beads being made of a rigid material and provided with an aforementioned seal and attached to a said mullion profile by means of the first positioning aids, wherein the first positioning aids and the one or more of said mullion profiles are designed to attach the first positioning aids, preferably by a snapping system, to a said mullion profile, wherein the first positioning aids and the first glazing bead are designed to position the first glazing beads together with their aforementioned seals onto the mullion profiles through a rotational movement, guided by the first positioning aids.

In this way, the first glazing beads can be easily attached, simply by inserting them in the rabbet of the mullion profile behind a mounted panel and positioning, e.g. snapping, them into place from the inside of the curtain wall. This allows the panels to be fitted from the inside.

This also allows greater freedom in the design of the mullion profiles, because the placement possibility for first glazing beads is already provided. The first positioning aids can already be attached prior to the installation of a panel, while a glazing bead can only be installed later, thus limiting the connection possibilities of a glazing bead directly to a mullion profile.

Also, connection points for the first glazing beads directly to the mullion profiles may be undesirable to prevent other technical problems, for example related to waterproofing or a construction process of a frame structure of mullion profiles and transom profiles. Thanks to the first positioning aids, first glazing beads for can still be used without connection points, that would otherwise be necessary.

It is an advantage of the installation of the first glazing beads through a guided rotational movement that the first glazing beads cannot be positioned or snapped onto the mullion profiles in an incorrect way or with an incorrect alignment.

Preferably, the first positioning aids are arranged and adapted to comprise a guiding surface for converting a linear movement of the first glazing beads towards the mullion profiles to the rotational movement suitable for positioning the first glazing beads onto the mullion profiles.

This confers the advantage that, even when the persons installing the curtain wall are not aware that the first glazing beads are to be positioned through a rotational movement and try to push the first glazing beads linearly straight or at an angle towards the mullion profiles, these persons cannot install or align the first glazing beads in an incorrect way.

Preferably, the first positioning aids and first glazing beads are designed such that the rotational movement occurs along a rotation axis parallel to the vertical extent of the mullion. This rotation axis is not necessarily stationary. The instantaneous rotation axis of the first glazing beads can change position during the rotational movement of these glazing beads. The change in position can be represented by a translation in the horizontal plane such that the instantaneous rotation axis remains parallel to the vertical extent of the mullion.

Preferably, the cross section of the first glazing beads is substantially U-shaped, comprising two legs that extend from a side wall. Preferably, the seals of the first glazing beads are attached to the second of both legs.

Preferably, the first positioning aids comprise a guiding structure for guiding the rotational movement of the first glazing beads. Preferably, the projection of the guiding structure on the horizontal plane embodies an arc. Preferably, the concave side of the guiding structure faces the rabet whereas the convex side of the guiding structure faces the mullion. Preferably, the guiding structure spans an angular extent equal to or inferior to 90° around an axis parallel to the vertical extent of the mullion. Preferably, the maximal radius of curvature of the guiding structure is equal or inferior to 20, 15, 10 mm. Preferably, the minimal radius of curvature of the guiding structure is equal or superior to 3, 5, 7 mm.

In some embodiments, the projection of the guiding structure on the horizontal plane embodies a substantially circular arc and the radius of curvature of the guiding structure is substantially equal to the length of the first of both legs of the first glazing beads.

In some embodiments, the projection of the guiding structure on the horizontal plane embodies an arc with progressively decreasing radius of curvature in the direction of rotation going from perpendicular to the panels to parallel to the panels and the minimum radius of curvature of the guiding structure is substantially equal to the length of the first of both legs of the first glazing beads.

Preferably, the first glazing beads are inserted with the first of both legs into the guiding structure of the first positioning aids at an angle to the mounted panel.

Preferably, the rotation required to position/snap the first glazing beads, together with their seals, onto the mullion profiles, is from a direction at an angle to the plane of the mounted panel to a direction perpendicular to the plane of the mounted panel. Preferably, the extent of this rotation is equal or inferior to 90°.

Preferably, in their final assembled position, the first of both legs of the first glazing beads rests with its side against a side wall of the mullion profiles and with its tip against the guiding structure of the first positioning aids.

Preferably, in their final assembled position, the tip of the second of both legs of the first glazing beads rests against the thermal insulation profiles of the mullions.

Preferably, in their final assembled position, the side wall of the first glazing beads sits flush with the side wall of the mullions.

Preferably, in their final assembled position, the seal of the first glazing beads is compressed between the second of both legs of the first glazing beads and the mounted panel. The friction established by the compressed seal helps to keep the first glazing beads into place, e.g. snapped into place.

In preferred embodiments, the first of both legs of the first glazing beads comprises a protruding feature on its side that will be in contact with the side wall of the mullion profiles in the final assembled position. At the corresponding location, the side wall of the mullion profiles comprises a recess, filled with a seal. In the final assembled position, the protruding feature on the side of the first of both legs of the first glazing beads compresses the seal in the side wall of the mullion profiles. The friction established by the compressed seal helps to keep the first glazing beads snapped into place.

Preferably, the first positioning aids are made of plastic and the first glazing beads are made of aluminium.

Thanks to plastic first positioning aids, costs can be saved on the relatively expensive aluminium.

In yet another preferred embodiment, the first positioning aids and the one or more said mullion profiles are adapted to snap the first positioning aids onto a said mullion section in a direction perpendicular to the plane of the panel in question, wherein the first positioning aids and the first glazing beads are arranged to snap the first glazing beads onto the mullion profiles through a rotational movement, the rotational movement being guided by the first positioning aids.

In yet another preferred embodiment, the first positioning aids are profiles extending over only a portion of the length of the first glazing beads.

In yet another preferred embodiment, each of the first glazing beads are secured to a mullion profile by a minimum of two first positioning aids, that are placed some distance apart.

Preferably, the distance between the first positioning aids is between 300 and 1200 mm.

Preferably the length of the first positioning aids is between 20 and 150 mm.

In yet another preferred embodiment, the one or more of said mullion profiles and the first glazing beads are arranged in such a way that the first glazing beads rest against the mullion profile with their side facing away from the panel in question.

In some embodiments of the invention, the one or more panels are secured by means of second glazing beads attached to a the transom profiles by means of second positioning aids, wherein the second positioning aids and the one or more transom profiles are designed to be able to attach the second positioning aids to a transom profile, wherein the second positioning aids and the second glazing beads are designed to position the second glazing beads together with their seals onto the transom profiles through a rotational movement, the rotational movement being guided by the second positioning aids.

In a preferred embodiment, the second positioning aids are arranged and adapted for converting a linear movement of the second glazing beads towards the transom profiles into the rotational movement.

In yet another preferred embodiment, the rotational movement of the second glazing beads occurs around a rotation axis parallel to the one or more transoms, from a direction at an angle to the plane of the one or more panels to a direction perpendicular to the plane of the one or more panels.

In yet another preferred embodiment, the second glazing beads are fixed to transom profiles only by means of second positioning aids.

In yet another preferred embodiment, the second positioning aids are profiles that extend over only a portion of the length of the second glazing beads and the second glazing beads are each attached to a transom profile by at least two second positioning aids that are spaced apart.

In yet another preferred embodiment, the second glazing beads are structurally similar to the first glazing beads and the second positioning aids are structurally similar to the first positioning aids. Thus, one or more of the structural features described in this disclosure in conjunction with the first glazing beads and/or the first positioning aids also apply to the second glazing beads and/or the second positioning aids.

The advantages mentioned in connection with the first glazing beads and the mullion profiles are therefore also applicable to the transom profiles and the second glazing beads.

The mullion profiles and transom profiles are preferably composite profiles, each of which is composed out of two or more sub-profiles, which are not necessarily made of the same material.

In a still another preferred embodiment, a barrier for water is provided at the fixing points of the transom profiles on the mullion profiles, wherein the barrier is adapted to divert this water to a said transom profile, wherein the transom profiles are adapted to drain this water to the exterior of the curtain wall.

Here, the exterior of the curtain wall is the side exposed to atmospheric influences.

The advantage is that the mullion profiles do not need to be equipped with water drains, but that any infiltration water in the curtain wall can be evacuated for each facade plane separately, as opposed to traditional curtain walls, where infiltration water is collected and drained across multiple facade planes.

This also results in a vertical and horizontal sealing of the mullion profiles for each panel, so that any possible water leak can be assigned with certainty to a problem with respect to the placement of that particular panel or the mullion profiles or transom profiles around that particular panel and finding and solving a problem is thus much easier.

While in the traditional curtain walls water is led from the transom profiles to the mullion profiles and drained from there, the curtain wall according to the invention is designed to guide water from each panel separately from the mullion profiles to the transom profiles and to drain the water therefrom.

Preferably, the transom profiles are designed to drain said water to the outside of the curtain wall because the transom profiles, or a different profile attached to the transom profiles, such as for example a glass frame, are equipped with water drainage openings on the outside, wherein these drainage openings are located at a distance from the mullion profiles. Preferably this distance is between 10 and 300 mm.

In a further preferred embodiment, the transom profiles are designed in such a way that the section of the transom profiles to which said water is diverted, is positioned horizontally or slanting to the outside, wherein the transom profiles comprise a sub-profile made in one piece; the sub-profile being part of said section to which said water is diverted and wherein the sub-profile is provided with an upright edge on the inside of said section.

The section is made of a single piece of aluminium and is therefore waterproof. Thanks to the upright edge, inward leakage is prevented, even if a small amount of water should come onto the transom profiles, as long as this amount does not rise above the edge.

In a still another preferred embodiment, the barriers are formed by flexible plastic or rubber sealing pieces, wherein the sealing pieces are placed on ends of the transom profiles and wherein the shapes of the mullion profiles and the sealing pieces are adapted to each other to achieve a watertight connection between the transom profiles and the mullion profiles at the locations of the aforementioned attachment points.

Such sealing pieces are a practical way of obtaining such a barrier, are durable over time and can accommodate any possible small movement of the curtain wall.

In yet another preferred embodiment, the sealing pieces are provided with a deformable hollow chamber to facilitate the placement of the sealing pieces.

Thanks to this deformable chamber, the sealing pieces can be deformed during the placement, facilitating the placement while retaining the desired shape after the placement.

In a further preferred embodiment, a sealing piece is provided at each of the two ends of the transom profiles, wherein at least one, and preferably exactly one, of the sealing pieces of a transom profile is slidable on the transom profile, preferably over a distance of at least 1 and up to 12 mm, to accommodate small movements.

Under the influence of the wind and over time, small deformities can occur in the curtain wall. In order to ensure that these do not lead to high stress, which could lead to a breakage, said slidability is desirable.

In yet another preferred embodiment, the sealing pieces comprise a flat end wall that is perpendicular to the profile direction of the transom profiles, wherein the end wall is completely closed in the profile direction of the transom profiles and the end wall is resting against a mullion profile.

This prevents any infiltration water from flowing past the sealing pieces and seeping downwards.

In a further preferred embodiment, the curtain wall comprises mullion profiles, transom profiles and one or more panels, wherein the mullion profiles are provided on each side with a groove for clamping the side edge of a panel, wherein the grooves have an access opening, wherein the access opening has a first dimension in horizontal direction, wherein the transom profiles in the horizontal direction and at right angles to the profile direction of the transom profiles have a second dimension, wherein the second dimension is larger than the first dimension, wherein the transom profiles in a non-horizontal direction at right angles to the profile direction have a third dimension, wherein the third dimension is smaller than the first dimension, so that the ends of the transom profiles fit through the access opening, in a rotated state of the transom profiles in which the direction of the third dimension is horizontal.

In this embodiment, the mullion profiles are made of a single piece or of multiple connected non-detachable sub-profiles.

Such a curtain wall is easy to build from the inside without requiring many actions, because the aforementioned features allow the transom profiles to be placed in a groove around their longitudinal axis, and then simply get their desired orientation by rotation and to be fixed in the grooves.

In yet another preferred embodiment, one or more walls of the grooves are provided with a recess in which a section of the transom profiles is located, wherein the transom profiles is supported vertically by a bottom edge of said recess.

This is an easy way to attach the transom profiles to the mullion profiles without requiring further attachments. In addition, such a suspension allows the transom profiles to have some play in their profile direction, which is desirable to accommodate stress in the curtain wall.

In yet another preferred embodiment, the transom profiles are Z-profiles, with a first vertical leg directing upward and located on the inside of the transom profile, a second vertical leg directing downward and located on the outside of the transom profile, and a horizontal spacer section between the first and the second leg.

Due to the vertical legs, sufficient rigidity is obtained, while the horizontal spacer section allows sufficient space to install a panel above the transom profile.

Indeed, due to this construction of the transoms, the openings for the panels defined by the mullions and transoms in the curtain wall are sufficiently large to enable the installation of the panels from the inside of the curtain wall.

In this embodiment, a panel that is to be installed is, for example, first placed slantingly with respect to the plane of the curtain wall opposite a said opening and in this slanting position, with a side edge in a deep rabbet of one of the two adjoining mullion posts, after which the panel, with this side edge as a pivot point, is rotated into the opening to then be shifted sideways until both side edges of the panel are fitted in a rabbet. After that, the glazing beads can easily be snapped into place as described.

Due to the shape of the transoms without a downwardly directed leg on the inside of the curtain wall, there is sufficient space between the transoms in the opening in the vertical direction on the inside of the curtain wall to allow a panel to rotate into place without it colliding with a top or lower edge against a transom.

In yet another preferred embodiment, the transom profiles are provided with an undercut groove which runs in the profile direction and with a rod inserted in the undercut groove, wherein the mullion profiles have a second groove for receiving the end of said rod projecting out from the undercut groove, thereby blocking any rotational movement of the transom profiles.

Such an arrangement prevents the transom profiles from being detached from the mullion profiles by rotation.

In a still another preferred embodiment, said grooves on the different sides of the mullion profiles have a different depth.

This also allows the panels to be placed from the inside by shuffling a panel into the deepest groove, then shifting it into the desired orientation and then shuffling it towards the shallow groove.

In yet another preferred embodiment, the mullion profiles and the transom profiles are composite profiles, each composed of two or more sub-profiles, wherein the sub-profiles are not necessarily made of the same material.

This results in good thermal insulation, for example by working with an aluminium outer and inner sub-profile, connected by insulating plastic profiles.

Preferably the panels are glass panels.

As was already mentioned, the first and second glazing beads are equipped with seals, also called gaskets, which form the actual connection with the panels. Typically, these gaskets are installed in a groove in the glazing beads. In curtain walls according to the prior art, this installation process happens on the construction site. Such an on-site installation brings important disadvantages.

First of all, it represents an additional action which is to be completed by the workers. It thus complicates and prolongs the on-site work, which results in additional costs, and leads to a higher chance of faulty execution.

Secondly, the seals or gaskets need to fit tightly into the glazing beads. Therefore, it is hard to push the seals properly into the intended grooves in the glazing beads. Usually, the workers end up by stretching the seal in order to reduce its circumference to ease the insertion. Once the stretched seal is inserted, it is cut to the length of the glazing bead. However, and herein lies the problem, a stretched seal does not instantly return to its resting length. When there is not sufficient time for the seal to return fully to its resting length prior to cutting, the seal will continue to shrink after it has been cut. This results in seals which are too short, thereby leaving gaps in the wind- and waterbarrier of the curtain wall and leading to reduced wind- and watertightness of the curtain wall.

In third place, a construction site is a dirty environment. If the gaskets are installed on-site, the dust and debris present on the construction site could get stuck between the gaskets and the surfaces of their respective grooves, thereby limiting the adhesion of the gaskets to the profiles and possibly compromising the air- and/or watertightness of the curtain wall.

To remedy these problems, it is an additional objective of the present invention to present an improved installation method for the seals of the glazing beads, which is capable of remedying the abovementioned and other problems. This installation method comprises the steps of:
in the workshop, inserting the seals into the grooves of the glazing beads;
in the workshop, cutting the inserted seals to a length that exceeds the length of the glazing beads, thereby providing excess seal that extends on both sides of a glazing bead;
on the construction site, removing the excess seal by cutting the seals to the length of the glazing beads.

This method effectively eliminates the known problems of installing the seals on-site. Because the seals are already installed in the workshop, fewer actions are required on site. Because the seals are installed in a controlled environment, there is far less chance of dust and debris soiling the seals, thereby possibly degrading their sealing performance against the panels, or infiltrating the grooves of the glazing beads, thereby deteriorating the air- and watertightness of the connection between the seals and the glazing beads. Furthermore, there is a far lower chance of erroneous insertion of the seals into the grooves or of downright omission of the seals. Finally, because the seals are cut to excess length in the workshop, they may complete their eventual shrinking process—due to the installation procedure—before their arrival on the construction site. When the seals are subsequently cut on the construction site, they cannot be cut too short. The method can be applied to both the first and the second glazing beads. If desired, the described method for the installation of seals can even be generalized to other profiles of the curtain wall.

### BRIEF DESCRIPTION OF THE DRAWINGS

With the intention of better showing the characteristics of the invention, a preferred configuration according to the present invention is described hereinafter by way of an example, without any limiting nature, with reference to the accompanying drawings, wherein:

FIG. 1 schematically represents an outer view of a curtain wall according to the invention;

FIGS. 2 and 3 schematically represent a cross-sectional view of the curtain wall of FIG. 1 taken along line II-II, in which parts are omitted for clarity's sake in both figures;

FIG. 4 schematically represents a cross-section of the curtain wall of FIG. 1 along line IV-IV;

FIG. 5 schematically represents a cross-section of the curtain wall of FIG. 1 along line V-V;

FIG. 6 schematically represents a part of the curtain wall of FIG. 1 and shows a step in the manufacturing procedure of the curtain wall of FIG. 1;

FIG. 7 schematically represents the result of the step of FIG. 6;

FIG. 8 schematically represents a part of the curtain wall of FIG. 1 and shows a step in the manufacturing process of the curtain wall of FIG. 1;

FIGS. 9 and 10 schematically show parts of the curtain wall of FIG. 1 in perspective;

FIG. 11 schematically shows a next step in the manufacturing process of the curtain wall of FIG. 1 in perspective;

FIG. 12 schematically represents in cross-section analogous to FIG. 5 a next step in the manufacturing process of the curtain wall of FIG. 1;

FIGS. 13 and 14 schematically represent in side view, and top view respectively, a next step in the manufacturing procedure of the curtain wall of FIG. 1;

FIGS. 15 and 16, schematically represent in side view, and top view respectively, a next step in the manufacturing procedure of the curtain wall of FIG. 1, and

FIG. 17 schematically represents the installation of the first glazing beads;

FIG. 18 schematically illustrates the problem with the installation of the glazing beads according to prior art document WO 2017/008014.

### DETAILED DESCRIPTION

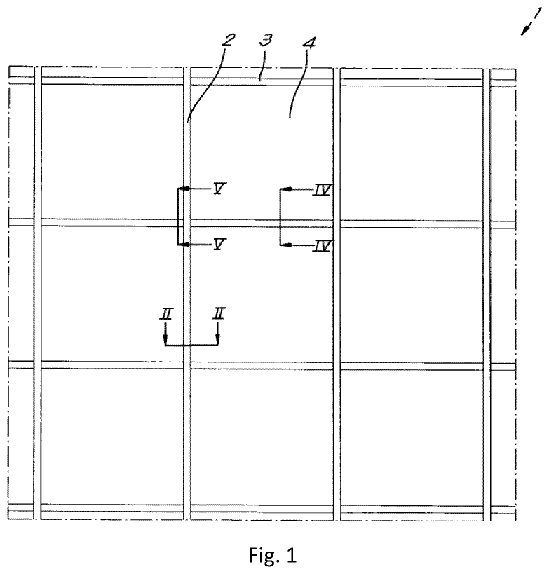

The curtain wall 1 shown in FIGS. 1 to 5 consists of a structure of vertical mullions 2 between which horizontal transoms 3 are attached. In the openings formed by the mullions 2 and the transoms 3, panels are placed, in this example, but not necessarily, glass panels 4, which are seated with their edges in the mullions 2 and the transoms 3.

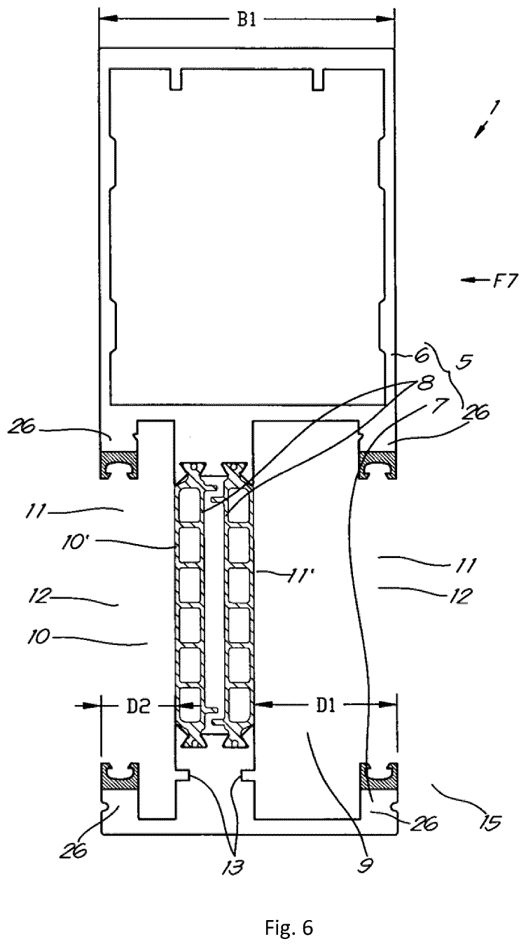

The mullions 2 are formed by mullion profiles 5 with a width B1 of 56 mm. The mullion profiles 5 are shown separately in a cross-sectional view in FIG. 6.

The vertical mullion profiles 5 consist of four sub-profiles, namely an aluminium tubular sub-profile 6 on the inside, an aluminium sub-profile 7 on the outside and two plastic insulation profiles 8. These four sub-profiles 6, 7, 8 are assembled into a monolithic entity by means of rolling, i.e. mechanical deformation of lips on the aluminium sub-profiles 6, 7 to clamp the plastic profiles 8.

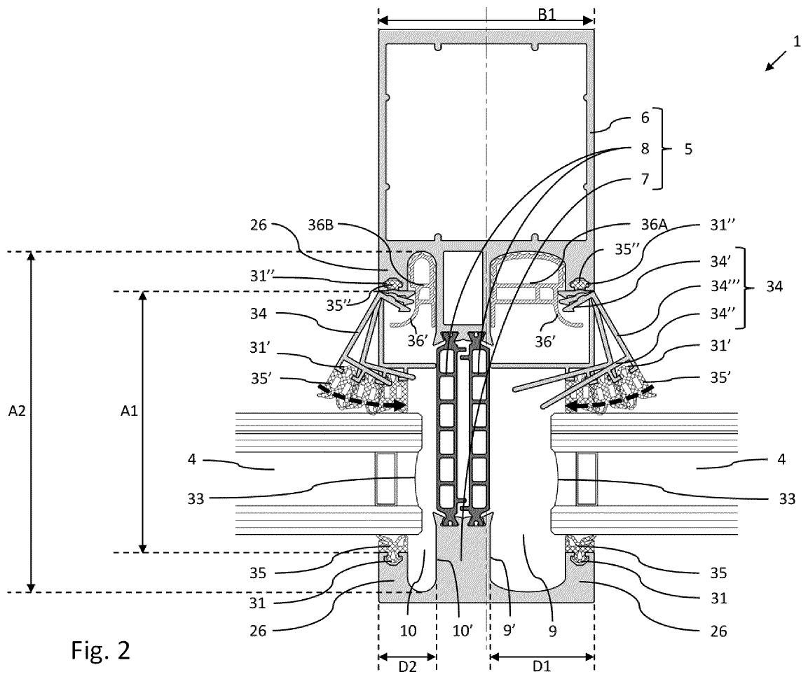

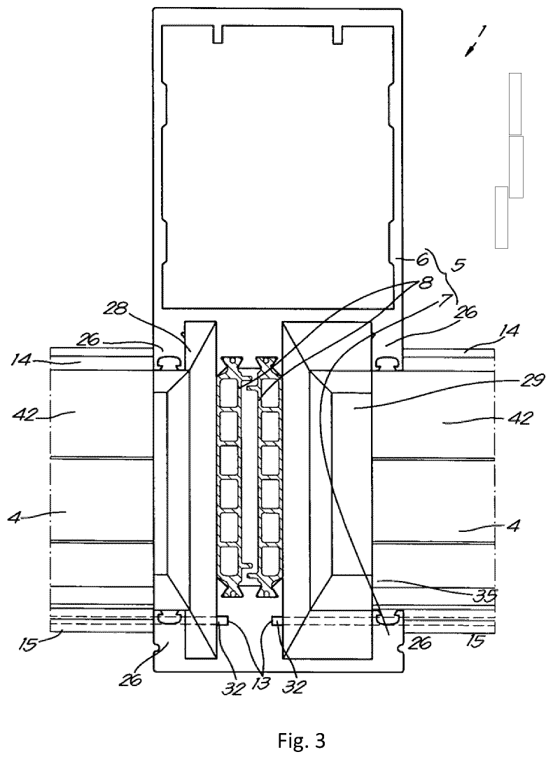

The mullion profiles 5 have a lateral undercut groove on both sides, namely a deep lateral groove 9 on one side, in FIGS. 2 and 3 on the right side, and a shallow groove 10 on the other side. The deep lateral groove 9 has a depth D1 of 28 mm, and the shallow lateral groove 10 has a depth D2 of 14 mm.

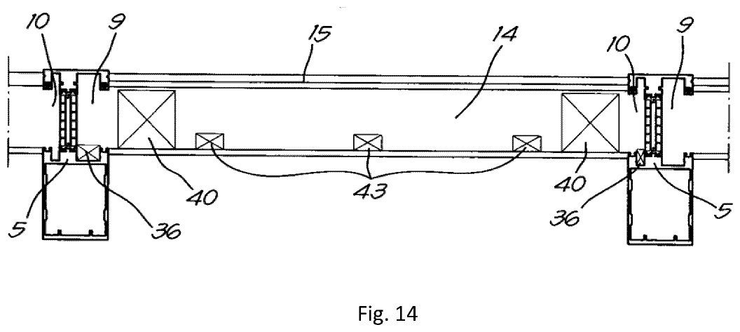

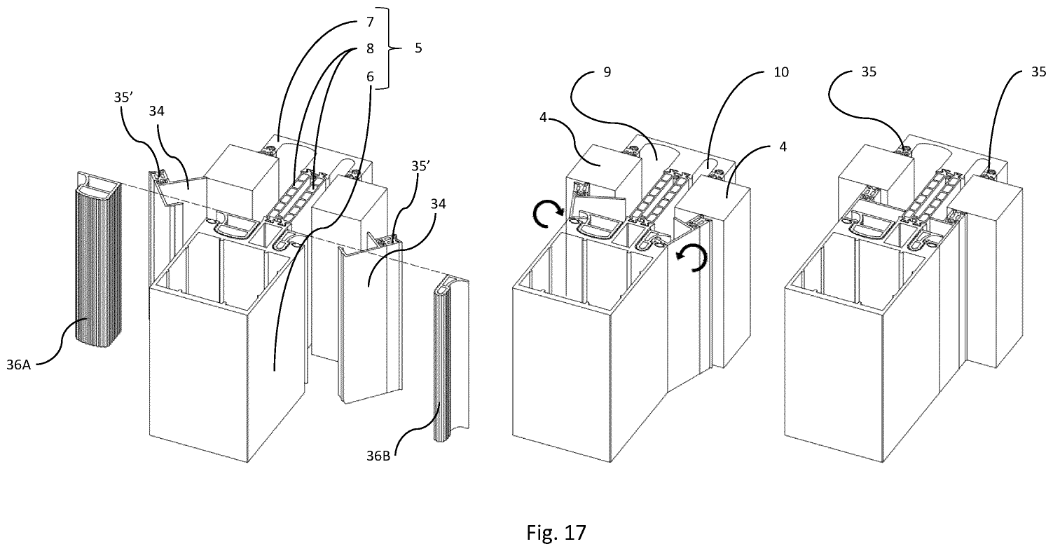

Both grooves 9 and 10 serve as a rabbet 11 for the side edges of the panels 4. The access opening 12 of the lateral grooves 9, 10 has a horizontal dimension, which is 54 mm wide. The maximum horizontal dimension A2 of the lateral grooves 9, 10 is approximately 76 mm. The cross-section of the grooves 9 and 10 can be rectangular in shape, as shown in FIGS. 3, 6, 11, 14 and 16, or oblong, as shown in FIGS. 2 and 17

The sub-profiles 6, 7 and 8 of the mullion profiles 5 are inseparably connected to each other, which means that they cannot be uncoupled from each other without causing irreversible damage. This means that the grooves 9 and 10 cannot be opened without damage and thus that the width A1 of the access opening 12 is a fixed size. At the bottom 9′ and 10′ of the two lateral grooves 9, 10 a narrow second groove 13 is provided.

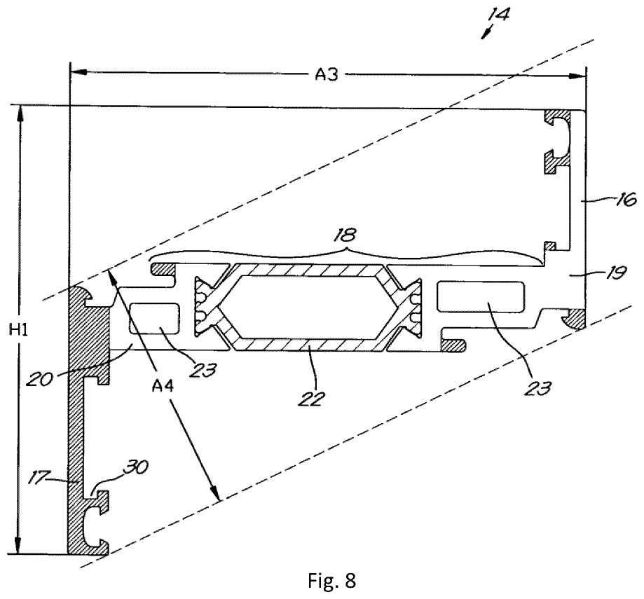

The transoms 3 are mainly formed by transom profiles 14 onto which an aluminium glazing beads 15 are attached to the outside of the curtain wall 1. The transom profiles 14 are shown separately in a cross-sectional view in FIG. 8.

The transom profiles 14 are Z-shaped profiles, having a first vertical leg 16 on the inside, a second vertical leg 17 on the outside and a section 18 between both legs 16, 17.

The transom profiles 14 have a total height H1 of 56 mm and a horizontal dimension A3 of 64 mm.

It is important to note that in a slanting direction, deviating approximately 60° from the horizontal direction, the transom profiles 14 have a much smaller dimension A4 of about 34 mm as shown in FIG. 8.

The transom profiles 14 consist of three sub-profiles, namely an aluminium inner sub-profile 19, a portion of which forms the first leg 16, an aluminium outer sub-profile 20, a portion of which forms the second leg 17 and a plastic insulation profile 22. These three sub-profiles 19, 20, 22 are firmly attached to each other by means of rolling, i.e. mechanical deformation of lips on the aluminium sub-profiles 19, 20 in order to clamp the plastic profiles 22.

The inner and outer section profiles 19, 20 are each provided with an internal chamber 23.

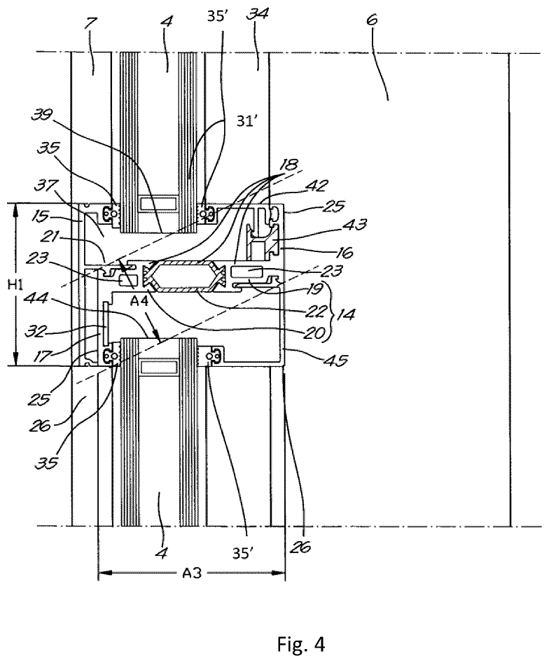

As illustrated in FIG. 4, the glazing beads 15 are provided with clipping parts 21 or other fastenings in order to attach them to the transom profiles 14, for example against the vertical leg 17 on the outside of the curtain wall 1.

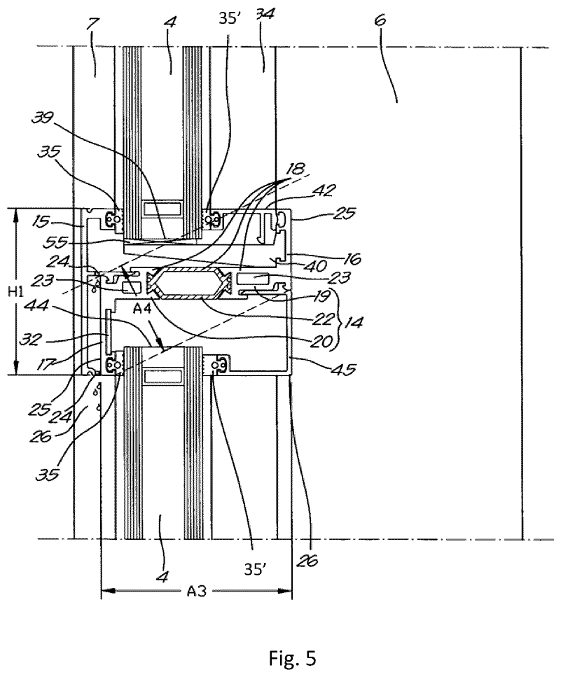

As is particularly apparent from FIG. 5, the glazing beads 15 are provided with water drainage openings 24 at a small distance from the mullion profiles 5. Such drainage openings 24 may additionally also be provided in one or more other locations in the glazing beads 15. This depends on the length of the transoms 3.

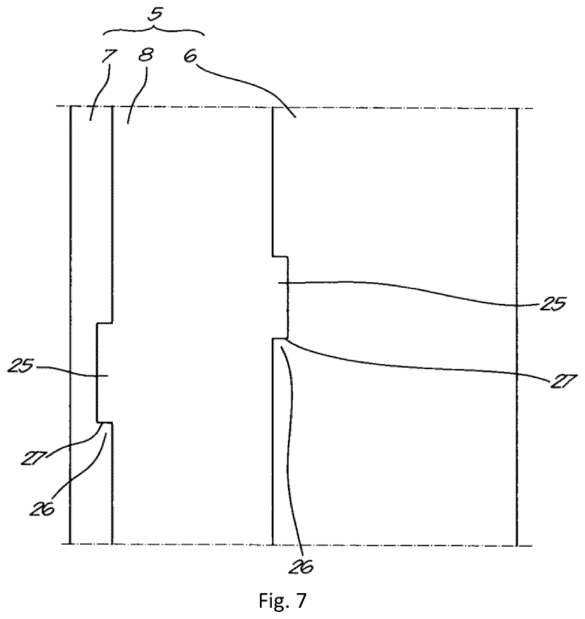

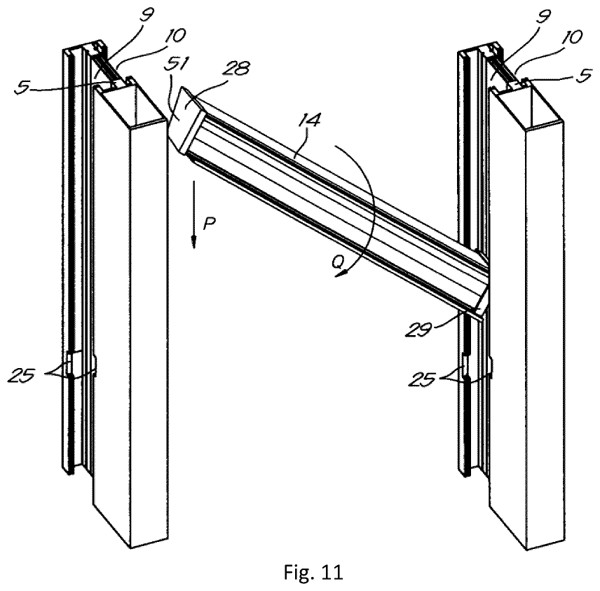

The transom profiles 14 are attached to the mullion profiles 5 because parts of the transom profiles 14, and more specifically the first and second legs 16, 17, rest in the recesses 25 shown in FIGS. 7 and 11 in the walls 26 of the lateral grooves 9, 10 of the mullion profiles 5 and are vertically supported by the bottom edge 27 of these recesses 25. How this is achieved will be explained later.

At the ends of the transom profiles 14, sealing pieces 28, 29 are provided that are made of rubber with a Shore hardness of 75. These sealing pieces 28, 29 fit exactly into the lateral grooves 9, 10 of the mullion profiles 5 and seal these grooves 9, 10 off in the vertical direction to prevent possible infiltration water coming into grooves 9 and 10 and constitute as such a vertical barrier, so that the water cannot possibly pass through to an underlying module—the so-called waterfall principle or cascade drain, but possible infiltrated water is individually drained from each panel (or facade plane) separately.

The transom profiles 14 are preferably equipped to drain this water to the outside of the curtain wall 1, with the upper side of the transom profile 14 slanting downwards to the outside of the curtain wall 1, for example.

The raised leg 16 on the inside of the curtain wall prevents water from infiltrating to the inside.

Details of these sealing pieces 28, 29 and the manner in which they are attached to the transom profiles 14 will be addressed later. These sealing pieces 28 and 29 are shown in FIGS. 3, 9 and 10 and are preferably manufactured in a single piece by injection moulding or the like.

In order to secure the attachment of the transom profiles 14 to the mullion profiles 5, the transom profiles 14 on the inside of the second leg 17 are provided with an undercut groove 30. At one or both ends of this undercut groove 30 is a rod, in this example an aluminium slat 32 mounted in the groove 30 so that it can be slid in the groove. When mounted, the slat 32 extends beyond the undercut groove 30 with a protruding end, said end is fitted in a second groove 13 of the mullion profiles 5 and acts as a lock.

Due to the fact that the groove 30 and the slat 32 are located on the inside of the outer vertical leg 17 of a transom profile 14, the transom profile 14, in its end position, can be locked from the inside during the construction of the curtain wall 1 by sliding slat 32 from a groove 30 into a groove 13 of a mullion profile 5.

The side edges 33 of the glass panels 4 are secured in the lateral grooves 9, 10 of the mullion profiles 5 by being fitted between the outer profile 7 of the mullion profiles 5 and the first glazing beads, also called vertical glazing beads 34 on the inside of curtain wall 1. In this setup, rubber gaskets 35 are placed between the outer profile 7 and the glass panels 4, rubber gaskets 35′ are placed between the vertical glazing beads 34 and the glass panels and rubber gaskets 35″ are placed between the vertical glazing beads 34 and the inner profile 6.

Preferably, the gaskets 35, 35′ and 35″ are installed in the respective grooves 31, 31′ and 31″, configured for receiving them, before the arrival of the elements of the curtain wall on the construction site. This is preferable because the most convenient way of installing the gaskets 35, 35′ and 35″ in the grooves 31, 31′ and 31″ is by stretching the gaskets longitudinally such that their cross-section is reduced, subsequently inserting the gaskets in the respective grooves and finally cutting the gaskets to the correct length. However, the gaskets have been stretched and thus lengthened. Since they experience considerable friction from their respective grooves, they will only return slowly to their original length. Therefore, if the gaskets are installed on site, they will continue shrinking in length after they have been cut, leading to gaskets that are too short and possibly compromise the air- and/or water-tightness of the curtain wall. This is also preferable because the dust and debris present on a construction site could get stuck between the gaskets and the surfaces of their respective grooves, thereby limiting the adhesion of the gaskets to the profiles and possibly compromising the air- and/or water-tightness of the curtain wall.

Preferably, the gaskets 35, 35′ and 35″ and their respective grooves 31, 31′ and 31″ are configured such that the gaskets are secured in the grooves by means of a snap mechanism.

Glazing beads are profiles made out of a rigid material and which serve with the aid of a gasket to accommodate the play between the thickness of the panels 4 and the width A1 of the rabbet 11 or rather: to accommodate the differences in thickness between thicker or thinner panels. These glazing beads have a width that has to be adjusted to the thickness of the panels that are to be installed.

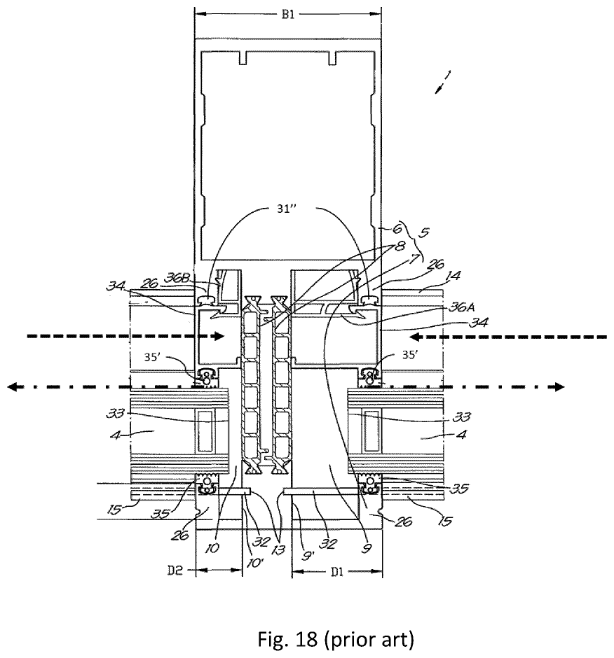

FIG. 18, which was adapted from prior art document WO 2017/008014, represents a horizontal cross-section of the curtain wall of prior art document WO 2017/008014, comparable to a cross-sectional view of the curtain wall of FIG. 1 taken along line II-II.

In the installation method according to WO 2017/008014, the glazing beads 34 are pushed towards the mullion profiles 5 in a direction parallel to the panels 4. This action is represented by the dashed line in FIG. 18.

However, during parallel movement of the glazing beads 34 with respect to the panels 4, the seals 35′ drag along the panels 4, thereby causing a friction force in a direction opposite to the direction of installation of the glazing beads. This friction force is represented by the dash-dotted line in FIG. 18.

Under the influence of the friction force, the glazing beads 34 can start to rotate along their vertical axis. If the installer of the glazing beads does not pay attention and continues to push the glazing bead 34 towards the mullion profile 5 without accounting for the resulting rotating force, the edge of the glazing bead 34 can get stuck in the recess 31″. In this case, the glazing bead 34 is stuck in a rotated position with respect to the panel 4 and does not properly fulfil its support and sealing functions. Generally, the glazing bead 4 cannot be removed from the incorrect rotated position without damaging the glazing bead 4, the seal 35′ or the mullion profile 5. This situation clearly illustrates the need for an improved attachment method for the glazing beads.

Returning to the present invention, the vertical glazing beads 34 are attached to the mullion profiles 5 by means of first positioning aids 36, used in two variants, namely a first variant 36A for use in the deep lateral groove 9 and a second variant 36B for use in the shallow lateral groove 10. These first positioning aids 36 are PVC profiles with a profile length of approximately 3 cm. At a distance of approximately 60 cm, they are snapped into the lateral grooves of the mullion profiles 5. Since the first positioning aids 36A and 36B are to be inserted in grooves 9 and 10, as shown in FIG. 2, their shape is adapted to the shape of the grooves 9 and 10.

Preferably, the surface of the first positioning aids 36A and 36B, designed to be in contact with the walls of the grooves 9 and 10, comprises an enhanced texture such as for example ribs or dots. Such a textured surface allows for improved adhesion when attaching the first positioning aids 36 to the mullion profiles 5 by means of a sealant or glue.

The vertical glazing beads 34 are in turn attached to the mullion profiles 5 through a rotational movement guided by the first positioning aids 36, as shown in FIG. 2 or 17.

The first positioning aids 36 and vertical glazing beads 34 are designed such that the rotational movement occurs along a rotation axis parallel to the extent of the mullions 2. To this end, the first positioning aids 36 comprise a guiding structure 36′ that is arranged and adapted to convert a linear movement, either straight or at an angle, of the glazing beads 34 towards the mullion profiles into the desired rotational movement.

The cross section of the glazing beads 34 is substantially U-shaped, comprising two legs 34′ and 34″ that extend from a side wall 34′″. The seals 35′ of the glazing beads 34 are attached to the leg 34″. Remark that in FIG. 2, the leg 34′ comprises one end of a snap-fit connection at its free end. This snap-fit connection serves no specific purpose in the present invention.

The glazing beads 34 are inserted with the leg 34′ into a guiding structure 36′ of the first positioning aids 36 at an angle to the mounted panel 4.

The rotation required to snap the glazing beads 34, together with their seals 35′, onto the mullion profiles 5, is from a direction at an angle to the plane of the mounted panel 4 to a direction perpendicular to the plane of the mounted panel 4, as indicated by the arrows in FIGS. 2 and 17.

The instantaneous rotation axis for the rotational movement of the glazing beads 34 may change position during the rotational movement. The change in position can be represented by a translation in the horizontal plane such that the instantaneous rotation axis remains parallel to the vertical extent of the mullions 2. The position of the instantaneous rotation axis is determined by the interaction of the tip of leg 34′ with the guiding structure 36′, the interaction of the leg 34′ with the sidewall 26 of the inner profile 6, the angle at which the leg 34′ is inserted into the guiding structure 36′ and the friction between the gaskets 35′ and the panels 4.

Preferably, the leg 34′ and the guiding structure 36′ are designed such that the resistance against the attachment of the glazing beads 34 due to the friction between the gaskets 35′ and the panels 4 increases gradually during the rotational movement.

In their final assembled position, the leg 34′ of the glazing beads 34 rests with its side against a side wall 26 of the mullion profiles 5 and with its tip against the guiding structure 36′ of the first positioning aids 36.

In their final assembled position, the tip of the leg 34″ of the glazing beads 34 rests against the thermal insulation profiles 8 of the mullion profiles 5.

In their final assembled position, the side wall 34′″ of the first glazing beads 34 sits flush with the side wall 26 of the mullion profiles 5.

In their final assembled position, the seal 35′ of the glazing beads 34 is compressed between leg 34″ of the glazing beads 34 and the mounted panel 4. Leg 34′ of the vertical glazing beads 34 comprises a protruding feature on its side that will be in contact with the side wall 26 of the mullion profiles 5 in the final assembled position. At the corresponding location, the side wall of the mullion profiles comprises a recess 31″, filled with a seal 35″. In the final assembled position, the protruding feature on the side of leg 34′ of the glazing beads 34 compresses the seal 35″ in the recess 31″ of the side wall 26 of the million profiles 5. The friction established by the compressed seals 35′ and 35″ keeps the glazing beads 34 into place.

The glazing beads 15 protrude to a certain height above the section 18 of the transom profiles 14 and together with the upwardly directed leg 16 of the transom profiles 14, they form a rabbet 37 for the lower edge 39 of an upper glass panel 4.

The lower edge 39 of the glass panels 4 is supported by glass supports 40 that are attached to the first leg 16 of the transom profiles 14, near the mullion profiles 5, as shown in FIG. 5.

The lower edge 39 of the glass panels 4 is fitted between the glazing beads 15 on the outside of the curtain wall 1 and a second glazing beads, also called horizontal glazing bead 42 on the inside. There are rubber gaskets 35′ inserted between the glazing beads 15 and the glass panels 4 and between the horizontal glazing beads 42 and the glass panels 4, as shown in FIG. 4.

The horizontal glazing beads 42 are attached to the transom profile 14 by means of second positioning aids 43 on the inside of the curtain wall 1 as shown in FIG. 4.

These second positioning aids 43 are PVC profiles with a profile length of approximately 3 cm. They are attached to the transom profiles 14 at intervals of about 60 cm and the horizontal glazing beads 42 are snapped onto the second positioning aids 43 by means of a rotational movement, similar to how the first glazing beads 34 are attached to the first positioning aids 36.

The upper edge 44 of the glass panels 4 is fitted between the glazing beads 15 on the outside of the curtain wall 1 and another horizontal glazing bead 45 on the inside which is provided with a rubber gasket 35′ and which is snapped directly onto the transom profile 14.

It is noted that in some figures parts have been omitted to make other parts more visible. This is especially true of FIGS. 2 and 3, where in FIG. 2 mainly the sealing pieces 28, 29 and the ends of the transom profiles 14 are omitted, and in FIG. 3, mainly the glass panels 4, the vertical glazing beads 34 and the first positioning aids 36 for the vertical glazing beads 34 are omitted.

The manufacture and construction of the curtain wall 1 as described above is as follows.

First, the mullion profiles 5 and transom profiles 14 are prepared. At the positions where the transom profiles 14 are to be connected to the million profiles, the million profiles are provided with recesses 25, especially in the walls 26 defining the access opening 12 of the lateral grooves 9, 10. This is shown by means of shading in FIG. 6, which indicates where material of the mullion profiles 5 is removed, for example by milling. The obtained result is shown in FIG. 7.

The transom profiles 14 are also prepared. At their ends, a part of the transom profile 14 is milled for a length of about 11 mm. Shading indicates this part in FIG. 8.

These steps are normally, but not necessarily, automated and performed in a specialized workshop before the profiles 5,14 are transported to the location where the curtain wall 1 is to be built.

Next, the required glass supports 40 and second positioning aids 43 are provided in a groove routed for this purpose in the first leg 16.

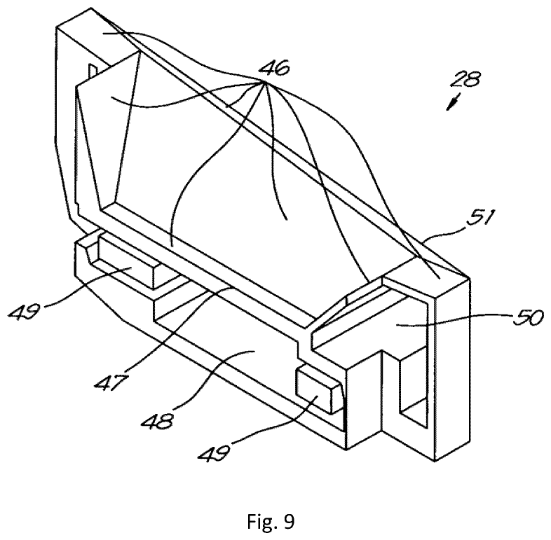

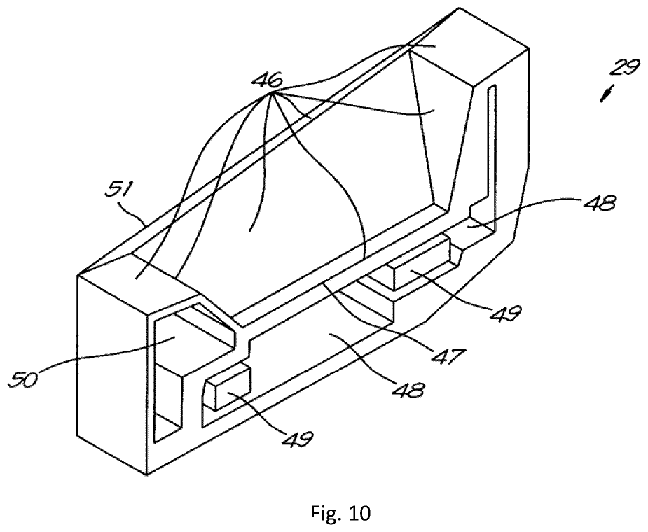

Subsequently, sealing pieces 28, 29 are slid on the ends. These are shown in FIGS. 9 and 10 and exist in two variants, i.e. a first variant 28 as shown in FIG. 9, to be placed on the end of a transom profile 14 intended to be fitted into the shallow lateral groove 10 of the mullion profiles 5 and a second variant 29, as shown in FIG. 10, to be placed on the end of a transom profile 14 intended to be fitted in the deep lateral groove 9 of the mullion profiles 5.

The pre-assembled sealing pieces 28, 29 attached to the transoms both have an upper surface 46 formed from planes slanting to a lowest point 47 away from the bottom 9′or 10′, respectively of the grooves 9 and 10 in which the sealing pieces 28, 29 are fitted. Also, both sealing pieces 28, 29 have a recess 48 for receiving the ends of the transom profiles 14 with two ridges 49 with corresponding positions and formats relative to the chambers 23 in the transom profiles 14.

These recesses 48 do not fully extend through the sealing pieces 28, 29. The walls 51 perpendicular to the transom profiles 14, i.e. the rear walls in FIGS. 9 and 10, are completely closed. The sealing pieces 28, 29 sealingly fit with these walls 51 against the bottom 9′ and 10′ of a groove 9 or 10 in which they have been mounted.

In top view, the sealing pieces 28, 29 are sized to fit precisely in the lateral grooves 9, 10.

Both sealing pieces 28, 29 are also provided with air chambers 50, wherein at the position of the air chambers 50, the outer wall is relatively thin so that the air chambers 50 are deformable.

The sealing pieces 28 according to the first variant are fixed permanently onto the transom profiles 14, for example by means of glue. The sealing pieces 29 of the second variant are slid onto the transom profiles 14 and are not secured further onto the transom profiles 14.

Then a previously mentioned aluminium slat 32 is fitted into the undercut groove 30 of the second leg 17 at both ends of the transom profiles 14.

Next, the mullion profiles 5 are mounted in their desired position.

Hereafter, the transom profiles 14, in an orientation in which they are rotated about 60° on their longitudinal axis and in which they are not horizontal, are held in the plane defined by the mullion profiles 14, as shown in FIG. 11.

The transom profiles 14 are now brought to a horizontal orientation, as indicated by arrow P, with the ends being inserted into the lateral grooves 9, 10 of the mullion profiles 5. Due to the direction of rotation of the transom profiles 14, rotated around their profile direction, these ends easily fit in the access openings 12 of these lateral grooves 9, 10.

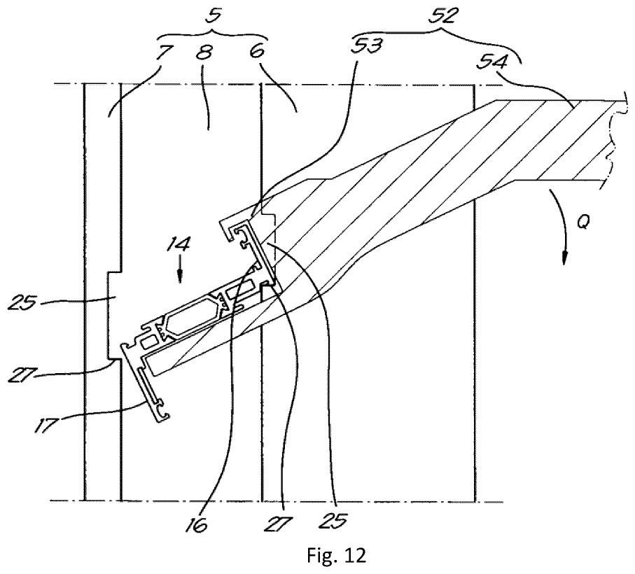

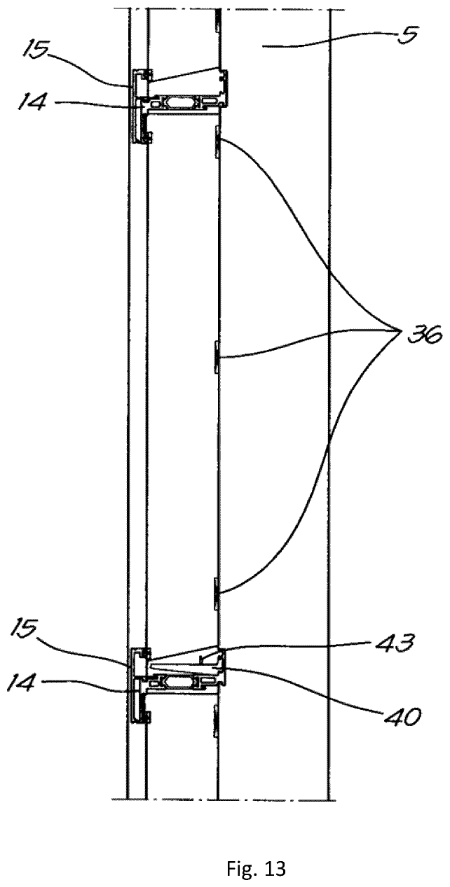

Then the transom profiles 14 are moved downwardly until they are in their desired position, i.e. at the recesses 25 in the mullion profiles 5. Then the transom profiles 14 are rotated as indicated by arrow Q. The situation as shown in FIG. 12 is now reached.

The transom profiles 14 need to be rotated even further, starting from the situation as shown in FIG. 12. Because this requires relatively much force, preferably a tool 52 is used. This is a tool 52 with a head 53 with a partially complementary shape to the transom profile 14 and a lever 54 attached to the head 53. The lever 54 of the tool 52 is moved in the direction of arrow Q until the transom profile 14, as shown in FIGS. 4 and 5, is positioned in its end orientation in the recesses 25.

The sealing pieces 28, 29, more specifically their air chambers 50, deform considerably during this operation, but resume their original shape when the transom profile 14 is in its final orientation. The sealing pieces 28, 29 hereby completely close the lateral grooves 9, 10 in the vertical direction.

Next, the glazing beads 15 are attached with the gaskets 35 to the sub-profile 20 of the transom profiles 14 on the outside of the curtain wall. This can easily be done from the inside of the curtain wall using the clips 21.

The glass supports 40 are pushed into their desired place, i.e. about 20 mm from the mullion profiles 5, and second positioning aids 43 are shifted until they are spread out over the length of the transom profiles 14, and the first positioning aids 36 for the vertical glazing beads 34 are snapped into their place as shown schematically in FIG. 17.

The glass frame are already provided with rubber gaskets 35 and neoprene blocks 55 are glued onto the glass supports 46, as shown in FIG. 5.

The slats 32 in the undercut grooves are pushed outwardly until they slide with an end into the second groove 13. They are then fixed in that position, for example with a little glue or by a screw. The transom profiles 14 can now no longer separate from the mullion profiles 5.

The construction can now be provided with glass panels 4.

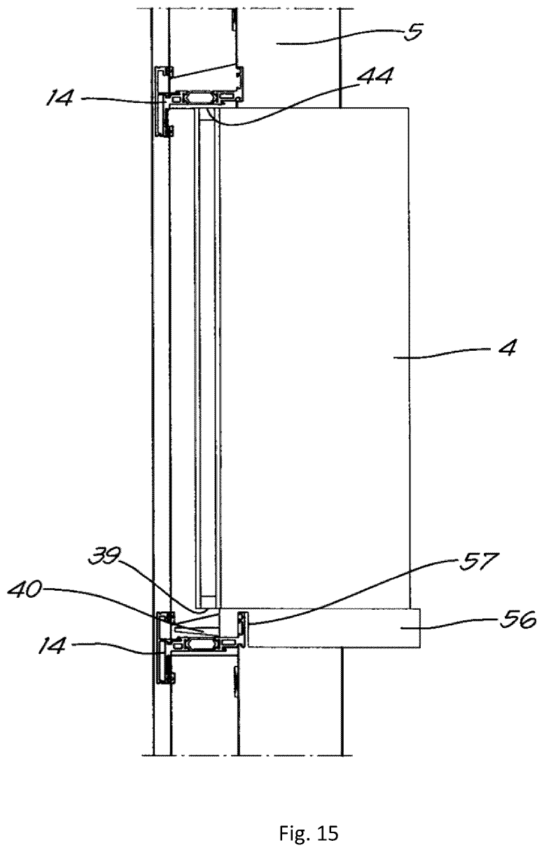

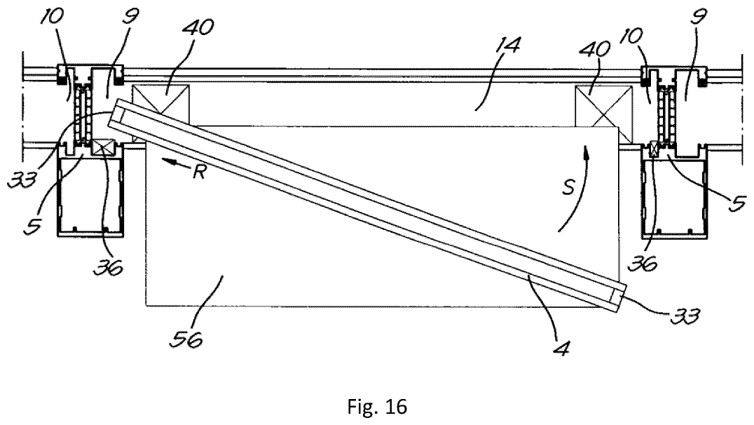

First, a wooden block 56 with a recess 57 for the first leg 16 is temporarily placed over the first leg 16. On top of this a glass panel 4 is placed in a slanted orientation. This is illustrated in FIGS. 15 and 16. The side edge 33 of the glass panel 4 that fits in the deep lateral groove 9 is now shuffled into this lateral groove 9 as indicated by arrow R.

Next, the other side edge 33 is shuffled along the opposite mullion section 5 as indicated by arrow S. To this end, the depth D1 of the groove 9 must be sufficient to shuffle the glass panel 4 sufficiently deep into this groove 9 with a pivotal movement of the glass panel 4 towards the shallow groove 10 and to then shuffle the glass panel 4 to the right, so that the glass panel 4 fits with both side edges 33 about 10 mm into a groove 9 or 10.

Then the glass panel 4 is centered so that it fits approximately 10 mm into both lateral grooves 9, 10 and then it is lowered onto the neoprene blocks 55. The wooden block 56 can now be removed.

Next, the horizontal and vertical glazing beads 34, 42, 45 and their gaskets 35′ can be applied. The glazing beads 34, 42, 45 can simply be snapped into place along the inside of the curtain wall 1. At the upper horizontal glazing bead 45, this is done directly onto the transom profile 14. The lower horizontal glazing bead 42 is snapped onto the transom profile 14 through a rotational movement, guided by the second positioning aids 43. The vertical glazing beads 34 are positioned/snapped onto the mullion profile 5 through a rotational movement, guided by the first positioning aids 36.

Now the final curtain wall 1, as shown in FIGS. 1 to 5, is built.

It is noted that, outside of the parts where the glass supports 40 are attached and located just next to the mullion profiles 5, the transom profiles 14 have no bearing function for the glass panels 4.

If water reaches the horizontal gaskets 35 on the outside, this water is diverted to the outside through the drainage openings 24 into the glass frames 15 as shown in FIG. 5. If water gets to the vertical gaskets 35 into the lateral grooves 9, 10, it is diverted via the upper surfaces 46 of the sealing pieces 28 and 29 to the transom profiles 14 and from there it is drained to the outside via the drain openings 24 in the glass frames 15.

If wind or other causes engender slight deformations of the curtain wall 1, the transom profiles 14 can slide a few millimetres into the sealing pieces 29 according to the second variant, which causes less stress to the curtain wall 1. Movements and deformation can also be absorbed by rubber sealing pieces 28 and 29 without jeopardizing the waterproofness of the curtain wall 1.

Although the construction method described above is done from the inside, it is also possible from the outside, although an installation from the inside usually has advantages.

The present invention is by no means limited to the embodiment described as an example and shown in the drawings, but a curtain wall according to the invention can be realized in all kinds of variants, without departing from the scope of the invention, as defined by the claims.

1-20. (canceled)

21. A curtain wall comprising
one or more mullions, formed by mullion profiles,
one or more transoms, formed by transom profiles and one or more panels,
wherein the one or more mullions are installed vertically,
wherein the one or more transoms are attached at right angles to the one or more mullions,
wherein the one or more transoms and the one or more mullions define rectangular openings,
wherein the one or more panels are placed in said openings to close these openings,
wherein the panels are fitted with their side edges in rabbets of the mullion profiles and of the transom profiles with the aid of seals,
wherein the rabbets in the mullion profiles have a fixed indivisible width and the one or more panels are secured along the inside of the curtain wall in the mullion profiles by means of first glazing beads that are made from a rigid material and are provided with seals and are attached to the mullion profiles by means of first positioning aids,
wherein the first positioning aids are attached to the one or more mullions,
wherein the first positioning aids and the mullion profiles are designed in such a way that the first positioning aids can be attached to the mullion profiles, and
wherein the first positioning aids and the first glazing beads are designed to position the first glazing beads together with the seals onto the mullion profiles through a rotational movement of the first glazing beads, said rotational movement being guided by the first positioning aids.

22. The curtain wall according to claim 21, wherein said first positioning aids are arranged and adapted for converting a linear movement of said first glazing beads towards said mullion profiles to said rotational movement.

23. The curtain wall according to claim 22, wherein said rotational movement occurs around a rotation axis parallel to the one or more mullions, from a direction at an angle to the plane of the one or more panels to a direction perpendicular to the plane of the one or more panels.

24. The curtain wall according to claim 21, wherein the first positioning aids and the mullion profiles are designed to snap the first positioning aids onto said mullion profiles.

25. The curtain wall according to claim 21, wherein the first glazing beads are made of aluminium.

26. The curtain wall according to claim 21, wherein the first positioning aids are made of plastic.

27. The curtain wall according to claim 21, wherein the first positioning aids and the mullion profiles are designed to snap the first positioning aids to the mullion profiles in a direction perpendicular to the plane of the one or more panels, wherein the first positioning aids and the first glazing beads are designed to snap the first glazing beads together with the seals onto the mullion profiles through a rotational movement, said rotational movement being guided by the first positioning aids.

28. The curtain wall according to claim 21, wherein the first positioning aids are profiles that extend over only a portion of the length of the first glazing beads.

29. The curtain wall according to claim 21, wherein the first glazing beads are each secured to a mullion profile by at least two first positioning aids that are spaced apart.

30. The curtain wall according to claim 21, wherein the mullion profiles and the first glazing beads are arranged such that the first glazing beads rest against the mullion profile, with their side facing away from the panel in question.

31. The curtain wall according to claim 21, wherein the one or more panels are glass panels.

32. The curtain wall according to claim 21, wherein the first glazing beads are fixed to mullion profiles only by means of first positioning aids.

33. The curtain wall according to claim 21, wherein the one or more panels are fixed by means of second glazing beads that are attached to a said transom profile by means of second positioning aids, wherein the second positioning aids and the one or more of said transom profiles are adapted to attach the second positioning aids to a said transom profile, wherein the second positioning aids and the second glazing beads 42) are designed to position the second glazing beads together with the seals onto the transom profiles through a rotational movement, said rotational movement being guided by the second positioning aids.

34. The curtain wall according to claim 33, wherein said second positioning aids are arranged and adapted for converting a linear movement of said second glazing beads towards said transom profiles to said rotational movement.

35. The curtain wall according to claim 34, wherein said rotational movement occurs around a rotation axis parallel to the one or more transoms, from a direction at an angle to the plane of the one or more panels to a direction perpendicular to the plane of the one or more panels.

36. The curtain wall according to claim 33, wherein the second glazing beads are fixed to transom profiles only by means of second positioning aids.

37. The curtain wall according to claim 33, wherein the second positioning aids are profiles that extend over only a portion of the length of the second glazing beads and that the second glazing beads are each attached to a transom profile, by at least two second positioning aids that are spaced apart.

38. The curtain wall according to claim 21, wherein the transom profiles are Z-profiles with a first vertical leg directing upward and located on the inside of the transom profile and a second vertical leg directing downward and located on the outside of the transom profile and a horizontal section between the first and second leg.

39. A method for installing a seal into a groove of a first glazing bead of a curtain wall according to claim 1, the method comprising the steps of:
in a workshop, inserting the seal into the groove of the first glazing bead;
in the workshop, cutting the inserted seal to a length that exceeds the length of the first glazing bead, thereby providing an excess seal that extends on both sides of the first glazing bead;
on a construction site, removing the excess seal by cutting the seal to the length of the first glazing bead.

40. The method according to claim 39, further comprising the steps of:
in the workshop, inserting a seal into a groove of a second glazing bead;
in the workshop, cutting the inserted seal to a length that exceeds the length of the second glazing bead, thereby providing an excess seal that extends on both sides of the second glazing bead;
on the construction site, removing the excess seal by cutting the seal to the length of the second glazing bead.
